(19) United States
(12) Patent Application Publication
(10) Pub. No.: US 2021/0190047 A1
(43) Pub. Date: Jun. 24, 2021

(54) Propulsion Boost System and Methods by Enhancing Plasma Thrust via Wake-Field Acceleration

(71) Applicant: Naval Information Warfare Center, Pacific, San Diego, CA (US)

(72) Inventor: Paul D. Swanson, Santee, CA (US)

(73) Assignee: United States of America as represented by Secretary of the Navy, San Diego, CA (US)

(21) Appl. No.: 16/724,834

(22) Filed: Dec. 23, 2019

(51) Int. Cl. F03H 1/00

(52) U.S. Cl. CPC F03H 1/0006

(57) ABSTRACT

A propulsion system involving a boost feature comprising a stationary electrical conductor, the boost feature configured to couple with a combustion engine, the stationary electrical conductor disposed in a path of a moving high-velocity plasma of exhaust from the combustion engine, and the stationary electrical conductor electrically biased, whereby the moving high-velocity plasma is accelerated, and whereby propulsion is boosted.

### FEDERALLY-SPONSORED RESEARCH AND DEVELOPMENT

The United States Government has ownership rights in the subject matter of the present disclosure. Licensing inquiries may be directed to Office of Research and Technical Applications, Naval Information Warfare Center, Pacific, Code 72120, San Diego, Calif., 92152; telephone (619) 553-5118; email: ssc_pac_t2@navy.mil. Reference Navy Case No. 104206.

### TECHNICAL FIELD

The present disclosure technically relates to propulsion. Particularly, the present disclosure technically relates to improving propulsion.

### BACKGROUND OF THE INVENTION

In the related art, various related art ionic thrusters currently exist, such as in relation to satellite gimbaling, in space. Wake-field acceleration is currently used in the related art to accelerate a group of charged particles that are injected, with high velocity, into a stationary plasma. In jet engines, gas turbines, a related art technique for improving propulsion involves using a technique referred to as afterburning, or “reheat,” which increases engine thrust for short time periods to improve take-off and climb performance. Fuel in a gas turbine burns in an excess of air. Sufficient oxygen is present to support further combustion. Additional fuel is injected and burned in the jet pipe, downstream of the turbine, to increase the engine thrust. In turbofan engines, where the bypass air provides even more oxygen, afterburners can achieve significant thrust increase.

Referring to FIG. 1, this diagram illustrates a flame 5 being pulled by a strong electric field E towards a high voltage electrode 7, wherein a component of the flame being caused by combustion is a plasma, in accordance with the related art. Referring to FIGS. 2A-2D, these diagrams illustrate a process of wake-field acceleration of free electrons e that are injected, with a velocity, into a plasma 10, in accordance with the related art. Referring to FIG. 2A, this diagram illustrates the plasma 10, having positive ions p and free electrons e, prior to entry of an electron “bunch” (FIGS. 2B-2D), in accordance with the related art. Referring to FIG. 2B, this diagram illustrates the plasma 10, as shown in FIG. 2A, having the positive ions p and the free electrons e, during entry of an electron “bunch” 20, thereby repelling the free electrons e from the plasma 10 in a path of the electron bunch 20, thereby displacing the free electrons e, thereby attracting the positive ions p from the plasma 10, and thereby beginning to form a wake W of positive ions 10 (FIGS. 2C and 2D) as the electron bunch 20 travels, e.g., in a direction D, in accordance with the related art. Referring to FIG. 2C, this diagram illustrates the plasma 10, as shown in FIG. 2B, having the positive ions p and the free electrons e, during travel of the electron bunch 20 therethrough, thereby attracting the displaced free electrons e to the positive ions p that have been disposed behind the electron bunch 20, and thereby forming the wake W of positive ions 10, in accordance with the related art. Referring to FIG. 2D, this diagram illustrates the plasma 10, as shown in FIG. 2C, having the positive ions p and the free electrons e, during continuing travel of the electron bunch 20 therethrough, and thereby having formed the wake W of positive ions 10, whereby the free electrons e that are disposed in their new position L, accelerate the electron bunch 20, in accordance with the related art.

However, the related art ionic thrusters and wake-field accelerators fail to provide any useful implementations for ionic thrust or wake-field acceleration in relation to vastly improving propulsion in relation to rockets and jet engines. Therefore, a need exists in the related art for technologies which significantly improve propulsion in relation to rockets and jet engines.

### SUMMARY OF INVENTION

To address at least the needs in the related art, the present disclosure generally involves a propulsion system, comprising: a boost feature comprising a stationary electrical conductor, the boost feature configured to couple with a combustion engine, the stationary electrical conductor disposed in a path of a moving high-velocity plasma of exhaust from the combustion engine, and the stationary electrical conductor electrically biased, whereby the moving high-velocity plasma is accelerated, and whereby propulsion is boosted.

### BRIEF DESCRIPTION OF THE DRAWING(S)

The above, and other, aspects, features, and benefits of several embodiments of the present disclosure are further understood from the following Detailed Description of the Invention as presented in conjunction with the following several figures of the drawings.

FIG. 1 is a diagram illustrating a flame being pulled by a strong electric field towards a high voltage electrode, wherein a component of the flame being caused by combustion is a plasma, in accordance with the related art.

FIG. 2A is a diagram illustrating a plasma, having positive ions and free electrons, prior to entry of an electron “bunch,” in accordance with the related art.

FIG. 2B is a diagram illustrating the plasma, as shown in FIG. 2A, having the positive ions and the free electrons, during entry of an electron bunch, in accordance with the related art.

FIG. 2C is a diagram illustrating the plasma, as shown in FIG. 2B, having the positive ions and the free electrons, during travel of the electron bunch therethrough, in accordance with the related art.

FIG. 2D is a diagram illustrating the plasma, as shown in FIG. 2C, having the positive ions and the free electrons, during continuing travel of the electron bunch therethrough, in accordance with the related art.

FIG. 3 is a diagram illustrating, in a cross-sectional view, a boost feature of a propulsion boot system and methods, in accordance with embodiments of the present disclosure.

FIG. 4 is a graph a propellant efficient profile, in terms of temperature, pressure, and velocity, of a rocket engine having a de Laval nozzle, with which the propulsion boost system and methods are implementable, in accordance with an embodiment of the present disclosure.

FIG. 5 is a graph illustrating a propellant efficient profile, in terms of temperature, pressure, and velocity, of a jet engine, with which the propulsion boost system and methods are implemented, in accordance with an embodiment of the present disclosure.

FIG. 6 is a diagram illustrating, in a cross-sectional view, a propulsion boost system, implementable with a jet engine, as shown in FIG. 5, in accordance with an embodiment of the present disclosure.

FIG. 7 is a flow diagram illustrating a method of fabricating a propulsion boost system, in accordance with an embodiment of the present disclosure.

FIG. 8 is a flow diagram illustrating a method of improving propulsion by way of a propulsion boost system, in accordance with an embodiment of the present disclosure.

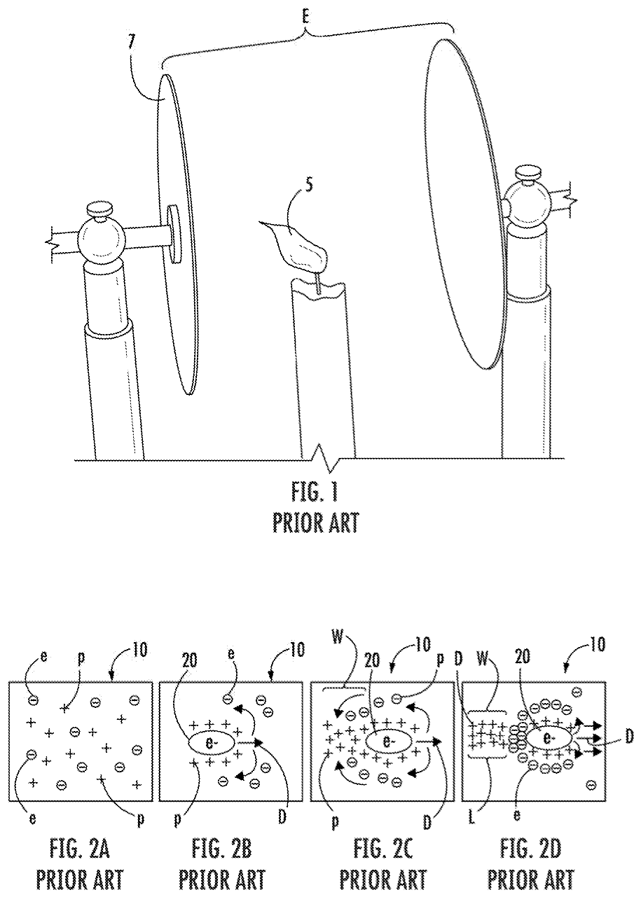

Corresponding reference numerals or characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION OF THE EMBODIMENT(S)

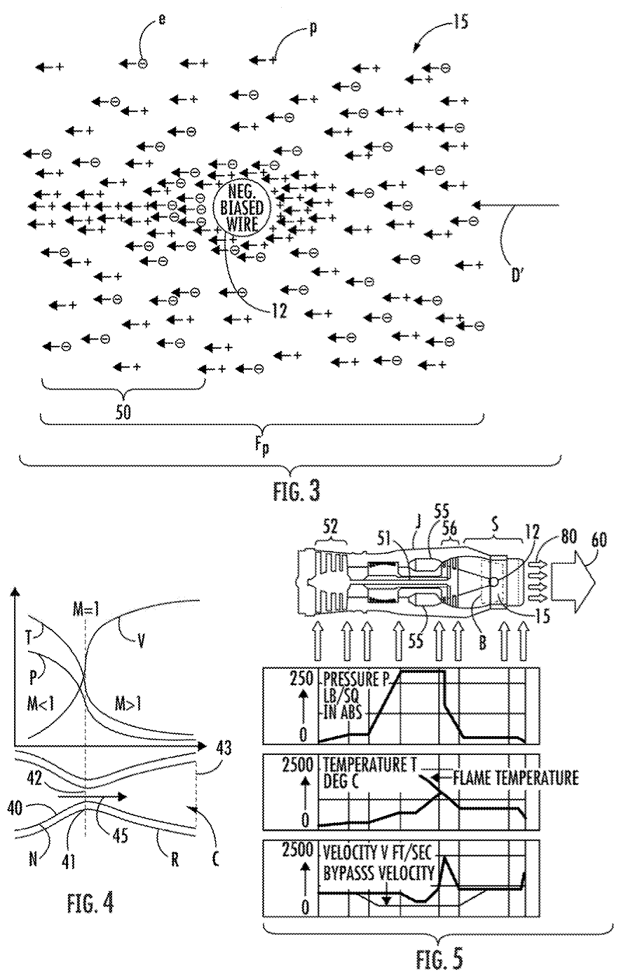

Referring to FIG. 3, this diagram illustrates a cross-sectional view of a boost feature of a propulsion boot system and methods, in accordance with embodiments of the present disclosure. In general, the boost feature is configured to accelerate a plasma or high-velocity plasma 15, e.g., comprising an exhaust plasma of a combustion engine, such as a jet engine J (FIG. 5) and a rocket engine R (FIG. 4), by example only, by applying an electric field thereto, thereby increasing velocity of the combustion engine's exhaust without increasing temperature of the exhaust. Instead of accelerating a charged bundle 20 through a stationary plasma 10 (FIGS. 2A-2D), as prescribed in the related art, the present disclosure systems and methods involve accelerating a high-velocity plasma 15 through, or past, an electrical conductor 12, such as a charged electrical conductor, e.g., at least one highly-charged wire, that is perpendicularly disposed in relation to a flow direction D′ of the high-velocity plasma 15, whereby the boost feature is operable as a thrust booster. The electrical conductor 12 is stationary (fixed) and may comprise a fixed charge bundle or any other highly charged conductor.

Still referring to FIG. 3, by example only, a plasma 15, e.g., a plasma gas, is accelerated by the electrical conductor 12. For example, the electrical conductor 12 comprises a plurality of wires. The number of wires in the plurality of wires (of the electrical conductor 12) is unlimited, provided that the density of the plurality of wires does not significantly inhibit gas flow, and that the distance between any two wires in the plurality of wires, in the direction D′ of plasma flow Fₚ, allows heavier ionic components to diffuse back behind a wire before a next wire is encountered. Acceleration of plasma 15 by the charged bundle 20 is facilitated by the negatively charged electrons e that diffuse back behind the wire which are much faster relative to travel of the heavier, slowing, moving ions p. The repelling Coulombic force between the electrical conductor 12 and the closely or proximately disposed electrons e will be much greater relative to the attracting Coulombic force that is exerted between the negatively charged electrical conductor 12 and the more-distant positively-charged ions p, thereby producing a net repulsive force between the electrical conductor 12 and the plasma 15, e.g., a high-velocity plasma. Regardless of whether a given force initially accelerates an electron e or an ion p, after collisions, a repulsive force has the net effect of accelerating the plasma 15 as a whole. The net acceleration of the plasma 15 is effected by the net repulsive force from all of the charged wires in the plurality of wires (of the electrical conductor 12) divided by the mass of the plasma 15. The magnitude of the net repulsive force increases with the negative charge on the electrical conductor 12 and with the velocity of the plasma 15 passing the electrical conductor 12. As the velocity of the plasma 15 increases, the area behind the electrical conductor 12, occupied by negatively-charged electrons e and void of positively-charged ions p, increases. The initial velocity of the plasma 15 is in a range of approximately 250 m/s (jet) to approximately 2900 m/s (rocket); and an acceleration of the plasma 15 is in a range expressed by Graham's Law of Diffusion, Coulomb's Law, and Newton's 2^{nd} Law of Motion as respectively follows:

$$Graham ’ s Law of Diffusion : \\ \frac{Rate at which ions return behind the wire}{Rate at which electrons return behind the wire} = \frac{\sqrt{Mass of the electron}}{\sqrt{Mass of the ion}} ; \\ Coulomb ’ s Law : \\ Force between wire and charge particle = \frac{1}{4 π {ɛ}_{o}} \frac{( Charge on wire ) ( Charge of particle )}{{( distance between particle and wire )}^{2}} ; and \\ Newton ’ s {2}^{n d} Law of Motion : \\ Acceleration = \frac{Force}{Mass} .$$

Still referring to FIG. 3, the present disclosure systems and methods involve accelerating a high-velocity plasma 15 through, or past, a stationary charge bundle, such as an electrical conductor 12, e.g., at least one wire, whereby a resulting wake-field 50 has a coulombic force that increases a velocity of the high-velocity plasma 15. The coulombic force decreases as the electrons and ions move away from the wire, e.g., the charged bundle 20, in accordance with Coulomb's Law. The stationary charge bundle, e.g., the charged bundle 20, comprises an electrical conductor, such as at least one thin wire, e.g., having a thickness in a range of approximately 0.025 mm to approximately 5 mm, by example only, perpendicularly disposed in relation to a flow direction of the high-velocity plasma 15, wherein a large negative electric bias is applied thereto. The large negative electric-static bias comprises a range of approximately −100 KV to approximately −5 MV, by example only. For example, a plurality of wires, such as a large number of wires, e.g., a number of wires in a range of approximately 1 wire to approximately near-∞ number of wires, are implemented for accelerating a larger plasma mass, e.g., having a moving mass in a range of approximately 0.0001 kg to approximately 2700 kg (in relation to a mass of an original bundle of free electrons.

Still referring to FIG. 3, the present disclosure systems and methods involve disposing the electrical conductor 12, such as the plurality of wires, at location(s) corresponding to maximum exhaust velocity in the combustion engine, such as a jet engine J (FIG. 5) and a rocket engine R (FIG. 4), the wake-field 50 is increased by the increasing velocity of, or accelerating, the high-velocity plasma 15 of the engine exhaust. For a jet engine J, the plurality of wires W is disposable in at least one location of: (a) forward of the turbine blades to increase turbine power and (b) aft of the turbine blades to increase exhaust thrust.

Referring to FIG. 4, this graph illustrates a propellant-efficient profile, in terms of temperature T, pressure P, and velocity V, of a rocket engine R having a rocket nozzle N, e.g., a de Laval nozzle, with which the propulsion boost system and methods are implementable, in accordance with an embodiment of the present disclosure. For the rocket engine R to be propellant-efficient, generating the maximum possible pressure on the walls 40 of the engine chamber C and the nozzle N by a specific amount of propellant (not shown) is crucial for at least that the maximum pressure is a source of thrust for the rocket engine R. Generating the maximum possible pressure is achievable by at least one technique of: (a) heating a propellant to a highest possible temperature by using a high-energy fuel, such as a fuel comprising at least one of hydrogen (H), carbon (C), and a metal, e.g., aluminum (Al); (b) using a low specific-density gas, such a highest possible hydrogen-rich gas; and (c) using propellants which are, or decompose to, simple molecules with few degrees of freedom to maximize translational velocity.

Still referring to FIG. 4, for at least that (1) the foregoing techniques minimize mass of the propellant, (2) the pressure incident on the engine is proportional to the mass of the propellant to be accelerated, and (3), from Newton's third law, the pressure incident on the engine also reciprocally acts on the propellant, for any given rocket engine R, the speed that the propellant leaves the engine chamber C is unaffected by the chamber pressure (although the thrust is proportional). However, speed is significantly affected by all three of the foregoing factors; and the exhaust speed corresponds to the rocket engine propellant efficiency. This correspondence is related to the engine's exhaust velocity; and, after allowance is made for factors that can reduce the engine's exhaust velocity, the effective exhaust velocity is one of the most important parameters of a rocket engine R, aside from other parameters, such as weight, cost, ease of manufacture, and the like.

Still referring to FIG. 4, for at least aerodynamic considerations, gas flow at the narrowest part of the nozzle, e.g., the “throat” 41, becomes sonic (Mach number˜/=1) or “chokes.” Since the speed of sound, in gases, increases with the square root of temperature, the use of hot exhaust gas greatly improves performance. By comparison, at room temperature, the speed of sound in air is about 340 m/s while the speed of sound in the hot gas of a rocket engine R can be over approximately 1700 m/s, largely due to the higher temperature. However, low molecular mass rocket propellants also impart a higher velocity in relation to air.

Still referring to FIG. 4, expansion in the rocket nozzle N further multiplies the speed, by a factor in a range of approximately 1.5 to approximately 2, thereby providing a highly collimated hypersonic (Mach number>>1) exhaust jet in a direction 45. The speed increase of a rocket nozzle is mostly determined by the rocket nozzle's area expansion ratio, e.g., the ratio of the area 42 of the throat to the area 43 at the exit. However, detailed properties of the gas in a plasma 15 are also important. Large ratio nozzles are more massive, but such large ratio nozzles are able to extract more heat from the combustion gases, thereby increasing the exhaust velocity, in relation to small ratio nozzles.

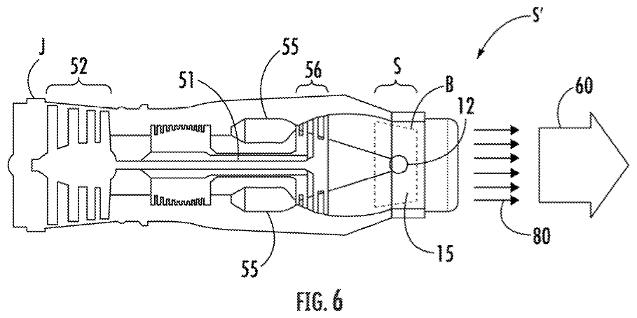

Referring to FIG. 5, this graph illustrates a propellant efficient profile, in terms of temperature T, pressure P, and velocity V, of a jet engine J (See also FIG. 6.), with which the propulsion boost system and methods are also implementable, in accordance with an embodiment of the present disclosure. A jet engine J, or a gas turbine, is an internal combustion engine, comprising a shaft 51, compressors 52, combustion chambers 55, and turbine blades 56, which produces power by a controlled burning of fuel. In a gas turbine, air is compressed, fuel is added, and the mixture is ignited. The resulting hot gas expands rapidly and is used to produce the power to move the craft (not shown), e.g., an aircraft or an aerospace craft. In the gas turbine, the burning is continuous; and the expanding gas is ejected from the engine as an action. A section of the gas turbine in which combustion takes place is referred to as the “hot end.” A force or reaction to the gas stream which is ejected from the nozzle of the gas turbine impinges on sections of the gas turbine that are opposite of the nozzle, e.g., mainly the front of the combustion chamber and the tail cone. This force, referred to as “thrust,” is transmitted from the gas turbine to the airframe (not shown), through the engine mountings (not shown), in order to propel the craft.

Referring to FIG. 6, this diagram illustrates a cross-sectional view of a propulsion boost system S, implementable with a jet engine J, as shown in FIG. 5, in accordance with an embodiment of the present disclosure. The propulsion system S comprises: a boost feature B comprising a stationary electrical conductor 12, the boost feature B configured to couple with a combustion engine, such as a jet engine J, the electrical conductor 12 (stationary) disposed in a path 60 of a plasma 15, e.g., a moving high-velocity plasma, of exhaust 80 from the combustion engine, and the electrical conductor 12 (stationary) electrically biased, whereby the plasma 15, e.g., the moving high-velocity plasma, is accelerated, and whereby propulsion is boosted.

Still referring to FIG. 6, in the system S, the electrical conductor 12 (stationary) is perpendicularly disposed in relation to the path 60 of the moving high-velocity plasma 15. For example, the electrical conductor 12 (stationary) comprises at least one wire. The at least one wire comprises a plurality of thin wires. The stationary electrical conductor comprises tungsten. The electrical conductor 12 (stationary) is negatively electrically biased for increasing thrust, whereby the boost feature B is operable as a thrust booster. The electrical conductor 12 (stationary) is negatively electrically biased to generate an acceleration of the plasma 15, e.g., the moving high-velocity plasma, whereby a wake-field 50 (FIG. 3) is increased.

Still referring to FIG. 6, the electrical conductor 12 (stationary) is disposed at a location corresponding to a maximum exhaust velocity in the combustion engine. By example, only, a system S′ further comprises the combustion engine, e.g., the jet engine J, wherein the combustion engine comprises one of a jet engine J and a rocket engine R. The jet engine J comprises a gas turbine; and the gas turbine comprises a plurality of turbine blades 56. The electrical conductor 12 (stationary) is disposed in at least one location of: forward of the plurality of turbine blades 56 to increase turbine power; and aft of the plurality of turbine blades 56 to increase exhaust thrust.

Referring to FIG. 7, this flow diagram illustrates a method M1 of fabricating a propulsion boost system S, in accordance with an embodiment of the present disclosure. The method M1 comprises: providing a boost feature B, as indicated by block 701, providing the boost feature B comprising providing a electrical conductor 12 (stationary), as indicated by block 702, providing the boost feature B comprising configuring the boost feature B to couple with a combustion engine, as indicated by block 703, such as a jet engine J, providing the electrical conductor 12 (stationary) comprising disposing the electrical conductor 12 (stationary) in a path 60 of a moving high-velocity plasma 15 of exhaust 80 from the combustion engine, as indicated by block 704, and configuring the electrical conductor 12 (stationary) for electrically biasing, as indicated by block 705, whereby the moving high-velocity plasma 15 is accelerated, and whereby propulsion is boosted. Alternatively, the steps of the method M1 may be performed in any other order, in accordance with embodiments of the present disclosure.

Still referring to FIG. 7, in the method M1, disposing the electrical conductor 12 (stationary), as indicated by block 704, comprises perpendicularly disposing the electrical conductor 12 (stationary) in relation to the path 60 of the moving high-velocity plasma 15. Providing the electrical conductor 12 (stationary), as indicated by block 702, comprises providing at least one wire. Providing the at least one wire comprises providing a plurality of thin wires. Providing the electrical conductor 12 (stationary) comprises providing tungsten. Configuring the electrical conductor 12 (stationary) comprises negatively electrically biasing the electrical conductor 12 (stationary) for increasing thrust, whereby the boost feature B is operable as a thrust booster. Configuring the electrical conductor 12 (stationary) comprises negatively electrically biasing the electrical conductor 12 (stationary) to generate an acceleration of the moving high-velocity plasma 15, whereby a wake-field 50 is increased.

Still referring to FIG. 7, the method M1 further comprises providing the combustion engine, as indicated by block 706. Providing the combustion engine, as indicated by block 706, comprises providing one of a jet engine J and a rocket engine R. Providing the jet engine J comprises providing a gas turbine, providing the gas turbine comprising providing a plurality of turbine blades 56. Disposing the stationary electrical conductor 12, as indicated by block 704, comprises disposing the stationary electrical conductor 12 at a location corresponding to a maximum exhaust velocity in the combustion engine. Disposing the electrical conductor 12 (stationary), as indicated by block 704, comprises disposing the electrical conductor 12 (stationary) in at least one location of: forward of the plurality of turbine blades 56 to increase turbine power; and aft of the plurality of turbine blades 56 to increase exhaust thrust.

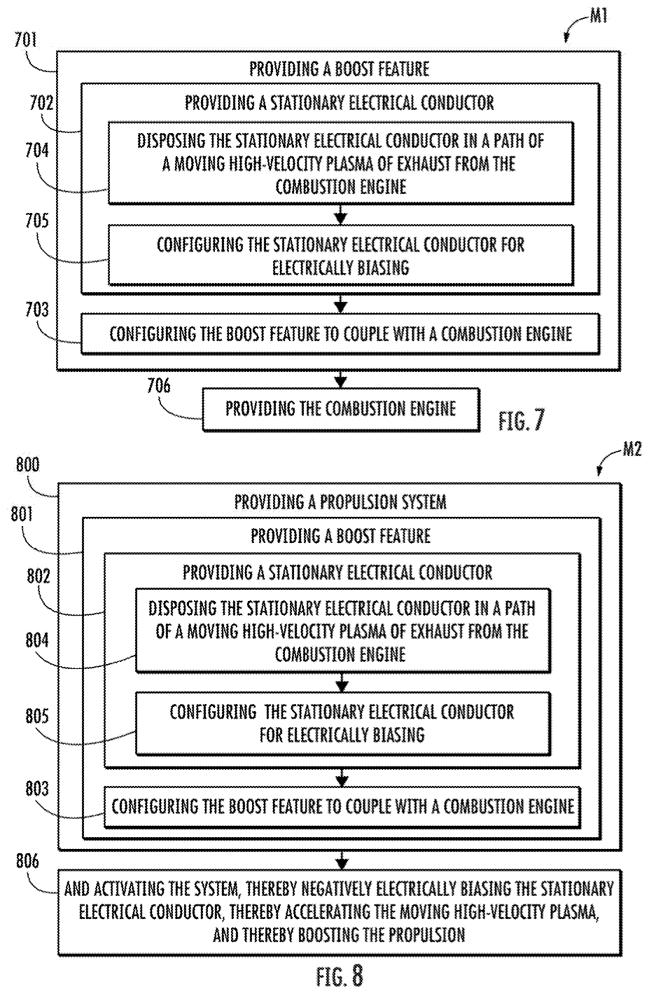

FIG. 8 is a flow diagram illustrating a method M2 of improving propulsion in a combustion engine by way of a propulsion boost system S, in accordance with an embodiment of the present disclosure. The method M2 comprises: providing the propulsion system S, as indicated by block 800, providing the system S comprising: providing a boost feature B, as indicated by block 801, providing the boost feature B comprising providing an electrical conductor 12 (stationary), as indicated by block 802, providing the boost feature B comprising configuring the boost feature B to couple with a combustion engine, as indicated by block 803, such as a jet engine J, providing the electrical conductor 12 (stationary) comprising disposing the electrical conductor 12 (stationary) in a path 60 of a moving high-velocity plasma 15 of exhaust 80 from the combustion engine, as indicated by block 804, and configuring the electrical conductor 12 (stationary) for electrically biasing, as indicated by block 805, whereby the moving high-velocity plasma 15 is accelerated, and whereby propulsion is boosted; and activating the system S, thereby negatively electrically biasing the electrical conductor 12 (stationary), thereby accelerating the moving high-velocity plasma 15, and thereby boosting the propulsion, as indicated by block 806. Alternatively, the steps of the method M2 may be performed in any other order, in accordance with embodiments of the present disclosure.

In alternative embodiments of the present disclosure, an electrical conductor, such as at least one wire, comprises any electrical conductor material that is capable of withstanding the temperature of the exhaust, e.g., tungsten (W) and the like. In alternative embodiments of the present disclosure, the high-velocity plasma 15 may be provided by any method other than combustion. By example only, depending on the anion/cation composition of the high-velocity plasma 15, the system and methods of the present disclosure may involve at least one positively-biased wire for accelerating the high-velocity plasma.

It will be understood that many additional changes in the details, materials, steps and arrangement of parts, which have been herein described and illustrated to explain the nature of the invention, may be made by those skilled in the art within the principle and scope of the invention as expressed in the appended claims.

1. A propulsion system, comprising:
a boost feature including a stationary electrical conductor, wherein the boost feature is configured to couple with a combustion engine and the stationary electrical conductor is disposed in a path of a moving high-velocity plasma of exhaust from the combustion engine, wherein the stationary electrical conductor is negatively electrically bias to repulse electrons and attract positively charged ions,
whereby the moving high-velocity plasma is accelerated, and
whereby propulsion is boosted.

2. The propulsion system of claim 1, wherein the stationary electrical conductor is perpendicularly disposed in relation to the path of the moving high-velocity plasma.

3. The propulsion system of claim 1, wherein the stationary electrical conductor comprises one or more wires, wherein the wires have a thickness ranging from 0.025 mm to 5 mm.

4. (canceled)

5. The propulsion system of claim 1, wherein the stationary electrical conductor comprises tungsten.

6. (canceled)

7. The propulsion system of claim 1, wherein the stationary electrical conductor is disposed at a location corresponding to a maximum exhaust velocity in the combustion engine.

8. The propulsion system of claim 1, further comprising the combustion engine, wherein the combustion engine comprises one of a jet engine and a rocket engine.

9. The propulsion system of claim 1, wherein the stationary electrical conductor is negatively electrically biased to generate an acceleration of the moving high-velocity plasma, whereby a wake-field is increased.

10. The propulsion system of claim 8,
wherein the jet engine comprises a gas turbine, the gas turbine comprising a plurality of turbine blades, and
wherein the stationary electrical conductor is disposed in at least one location of:
forward of the plurality of turbine blades to increase turbine power; and
aft of the plurality of turbine blades to increase exhaust thrust.

11. A method of fabricating a propulsion system, comprising:
providing a boost feature, wherein the boost feature is coupled with a combustion engine;
providing a stationary electrical conductor, wherein the stationary electrical conductor is disposed in a path of a moving high-velocity plasma of exhaust from the combustion engine and wherein the stationary electrical conductor is negatively electrically bias to repulse electrons and attract positively charged ions,
whereby the moving high-velocity plasma is accelerated, and
whereby propulsion is boosted.

12. The method of claim 11, wherein disposing the stationary electrical conductor comprises perpendicularly disposing the stationary electrical conductor in relation to the path of the moving high-velocity plasma.

13. The method of claim 11, wherein providing the stationary electrical conductor includes one or more wires, wherein the wires have a thickness ranging from 0.025 mm to 5 mm.

14. (canceled)

15. The method of claim 11, wherein providing the stationary electrical conductor comprises providing tungsten.

16. (canceled)

17. The method of claim 11, wherein disposing the stationary electrical conductor comprises disposing the stationary electrical conductor at a location corresponding to a maximum exhaust velocity in the combustion engine.

18. The method of claim 11, further comprising providing the combustion engine,
wherein providing the combustion engine comprises providing one of a jet engine and a rocket engine,
wherein, if providing the jet engine, providing the jet engine comprises providing a gas turbine, providing the gas turbine comprising providing a plurality of turbine blades, and
wherein if providing the jet engine, disposing the stationary electrical conductor comprises disposing the stationary electrical conductor in at least one location of: forward of the plurality of turbine blades to increase turbine power; and aft of the plurality of turbine blades to increase exhaust thrust.

19. The method of claim 16, wherein negatively electrically biasing the stationary electrical conductor the stationary electrical conductor generates an acceleration of the moving high-velocity plasma, whereby a wake-field is increased.

20. (canceled)

21. The propulsion system of claim 1, wherein the stationary electrical conductor has negative electric-static bias ranging from −100 KV to −5 MV.

22. The method of claim 11, wherein the stationary electrical conductor has negative electric-static bias ranging from −100 KV to −5 MV.

23. A propulsion system, consisting of:
a boost feature including a stationary electrical conductor, wherein the boost feature is configured to couple with a combustion engine and the stationary electrical conductor is disposed in a path of a moving high-velocity plasma of exhaust from the combustion engine;
wherein the stationary electrical conductor is negatively electrically bias to repulse electrons and attract positively charged ions;
whereby the moving high-velocity plasma is accelerated, and
whereby propulsion is boosted
